(19) United States
(12) Patent Application Publication
(10) Pub. No.: US 2007/0117950 A1
(43) Pub. Date: May 24, 2007

(54) Melt transurethane process for the preparation of polyurethanes

(75) Inventors: Manickam Jayakannan, Kerala (IN); Deepa Puthanparambil, Kerala (IN)

Correspondence Address: LADAS & PARRY, 26 WEST 61ST STREET, NEW YORK, NY, 10023, US

(73) Assignee: COUNCIL OF SCIENTIFIC AND INDUSTRIAL RESEARCH

(21) Appl. No.: 11/386,050

(22) Filed: Mar. 21, 2006

(30) Foreign Application Priority Data
Sep. 12, 2005 (IN) 3334/DEL/2005

(51) Int. Cl. C08G 71/04

(52) U.S. Cl. 528/45; 528/95

(57) ABSTRACT

This invention provides a melt transurethane process for the preparation of polyurethanes under solvent free melt conditions. In the transurethane process, a di-urethane monomer is reacted with diol under the melt condition in presence of catalyst like Ti (OBu)₄. The high molecular weight of the polymers are achieved by the continuous removal of low boiling alcohol like methanol from the polymerization medium under nitrogen purge and subsequently applying high vacuum. The transurethane process is demonstrated successfully for various diols units such as oligoethylene glycols, simple alkyldiols, cycloaliphatic diols and polyols. The polyurethanes are found to be soluble and thermally stable up to 300 ° C. for various high temperature applications. The thermal properties such as glass transition temperature in the polyurethanes can be easily fine-tuned by using various di-urethane and diols in the transurethane process. The present invention describes an isocyanate free polymerization route for polyurethanes under melt conditions and the transurethane process is non-hazardous and environmental friendly. The present approach is very efficient for producing high molecular weight polyurethanes and also has potential for large scale preparation.

### FIELD OF INVENTION

The present invention relates to method for development of polyurethanes, more specifically “a novel melt transurethane process for the preparation of polyurethanes”. The present process comprises the preparation of polyurethanes in solvent free, non-hazardous, environmental friendly and non-isocyanate conditions. The invention further relates to methods of the preparation of di-urethane monomers and their application in the said transurethane process.

### BACKGROUND OF INVENTION

Polyurethane is an interesting class of thermoplastic elastomers having thermo-reversible hydrogen bonded cross-links in the polymer matrix. These elastomers are more attractive in the fiber industry, because they can be processed by conventional melt and solution spinning methods. Typically, polyurethanes are prepared by the solution route via the condensation of aromatic or aliphatic diisocyanates with long chain diols or polyols [referred from Frisch, K. C.; Klempner, D.; In Comprehensive Polymer Science; Allen, G.; Bevington, J. C.; Eds, Pergamon Press, New York, 1989, chapter 24, page 413]. The urethane linkages in the polyurethane behaves as ‘virtual cross-linked’ hard segments and are surrounded by the soft long chain networks. The hard domains contribute to the thermo-reversibility, high glass transition temperature and hardness of the polyurethanes [described in Kojio, K.; Fukumaru, T.; Furukawa, M. Macromolecules 2004, 37, 3287]. These materials have gained a good market in the plastic industry and the demand for the thermoplastic elastomers rise significant in the plastic economy. Unfortunately, in the case of aromatic polyurethanes, the urethane linkages undergo thermal degradation (above 130° C.) and thus rendering it inappropriate for high temperature melt processing [described in Velankar, S.; Cooper, S. L. Macromolecules 1998, 31, 9181.]. Many attempts are reported to improve the thermal stability of the polyurethanes and some of them include the copolymers of urethane-urea, urethane-ester, urethane-ether and urethane-imides [Ning, L.; De-Ning, W.; Sheng-Kang, Y. Macromolecules 1997, 30, 4405 and Garrett, J. T.; Siedlecki, C. A.; Runt, J. Macromolecules 2001, 34, 7066]. The isocyanates used in polyurethane form, adhesive and fiber industry are identified as highly hazardous and has been found to cause significant health problem for the persons working with these materials. Additionally, the unreacted isocyanate monomers left in the polyurethane during the manufacturing are also found to be hazardous and limit their application many consumer products. Because of these problems, the strict regulations on health concerns are enforced in the polyurethane industry through out the world. The isocyanate is also highly moisture sensitive and it needs high purity solvents and inert atmosphere for the laboratory or industrial productions. Therefore, developing new process based on non-hazardous, environmental friendly, solvent free and non-isocyanate polymerization methodologies are very attractive and also essential requirement for the preparation of polyurethanes.

Over the past, many efforts have been made to prepare polyesters, polycarbonates and polyethers by solvent free melt conditions. In the case of polyesters and polycarbonates, dicarboxylic esters are reacted with diols at 260-280° C. under the transesterification conditions to make high molecular weight polymers [Referred from WhinField, J. R. Nature, 1946, 158, 930 and Pilati, F. In Comprehensive Polymer Science; Allen, G.; Bevington, J. C.; Eds, Pergamon Press, New York, 1989, chapter 17, page 275]. The melt transesterification process is also well-adapted in polyester industry to make reactive blending between polyesters and polycarbonates. [described in Jayakannan, M.; Anilkumar, P. J. Polym. Sci. Polym. Chem. 2004, 42, 3996 and Zhang, Z.; Luo, X.; Lu, Y.; Ma, D. J. Appl. Polym. Sci. 2001, 80, 1558]. Recently a melt transetherification is developed for the preparation of polyethers by reacting bis-benzyl methyl ether with diols at 180-200° C. [Jayakannan, M.; Ramakrishnan, S. Chemical Commun, 2000, 1967. and Jayakannan, M.; Ramakrishnan, S. J. Polym. Sci. Polym. Chem. 2001, 39, 1615]. However, up to our knowledge, there is no report so far known for preparing polyurethane via solvent free melt conditions, which would be very attractive for large scale preparation of polyurethanes in isocyanate free and environmental friendly routes.

In the light of the foregoing the applicant proposes a novel melt transurethane reaction for polyurethanes and the process represented in formula (1) diagrammatically.

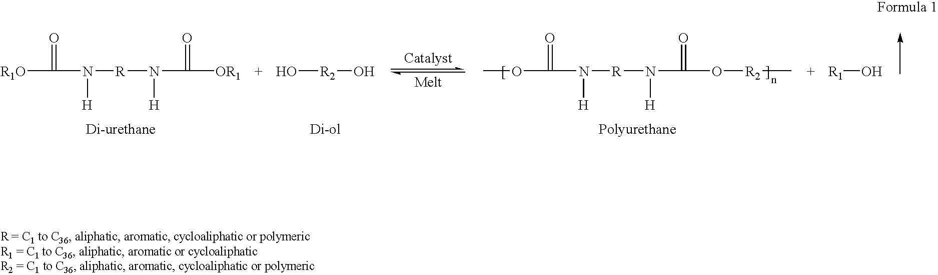

The new process described in formula 1 is very efficient for the preparation of polyurethanes under the melt conditions and the process can be used to prepare polyurethanes containing aromatic, aliphatic and cycloaliphatic derivatives. One of the significant features of the melt transurethane process is that the di-urethane monomer described in the process is non-hazardous and stable in the ambient conditions. It facilitates the preparation, purification and easy handling of di-urethane monomer compared to that of isocyanate monomers in the laboratory or industry. The process typically involved by the reaction of diols with di-urethane monomers to produce oligomeric polyurethane chains, which subsequently undergo polycondensation reaction to produce high molecular weight polyurethanes. High molecular weight polymers are readily obtained by the continuous removal of the low boiling alcohol, driving the equilibrium to the polymer formation. During the polycondensation, the urethane linkage undergoes transformation from one to another, which term the entire process as “transurethane”. The condensate removed from the process (R₁OH) is a simple alcohol like methanol, ethanol or low molecular weight alcohols, which is very common by-product in the plastic industry. Therefore both the monomers and condensate are environmental friendly in the melt transurethane process, which makes them more attractive compared to that of conventional hazardous isocyanate and alcohol reaction used in the polyurethane industry. The present invention emphasizes on the direct utilization of di-urethane monomers with many commercially available simple diols and polyols containing polyether, polyester, polycarbonate, polyamide or polymethylene chains for making polyurethanes through solvent free melt process. The present process is very efficient in producing high molecular weight polyurethanes and the process can be adopted for many types of polyurethanes such as simple random copolymers, block copolymers, random branched, hyperbranched polymers, graft and liquid crystalline polymers and biodegradable and biocompatible polymers, etc. The present melt transurethane process is also very efficient for reactive blending of polyurethanes with many thermoplastic polymers such as polyesters, polycarbonates, polyamides, polyethers, polysulfones, polyimides, polyvinyl alcohol and other thermoplastic/thermosets containing epoxy, amino and unsaturated groups in the main or side chains. The polyurethanes prepared by the present process are stable up to 300° C. for various high temperature applications.

### OBJECTIVES OF THE INVENTION

The main objective of the present invention is, therefore, to provide ‘a melt transurethane process for the preparation of polyurethanes’ under the solvent free and environmental friendly conditions.

Another object of the invention is to provide a process for the preparation of polyurethanes directly from commercially available polyols and simple diols containing aromatic, aliphatic and cycloaliphatic ring structures.

Still another object of the invention is to provide a process for the synthesis of di-urethane monomers and polymerizing the non-hazardous monomers with diols under the melt transurethane process for high molecular weight polyurethanes.

Yet another objective of the present invention is to provide a process for the preparation of high molecular weight polymers under melt condition from monomers containing AB, AₓB and ABₓ types functionalities, in which x=2, 3, 4, 5. n

Yet another objective of the present invention is to provide a process for the preparation of high molecular weight polymers under melt condition from monomers having multiple functional groups.

Yet another objective of the present invention is to provide a process for the preparation of high molecular weight polymers under melt condition from polyols containing polymers such as polyesters, polyethers, polyamides, polycarbonates, polysulfones, poly acrylics, polystyrene, etc.

Yet another objective of the present invention is to provide a process for the preparation of polyurethane at high temperature melt conditions accompanied with high temperature processing techniques such as injection and compression molding.

Yet another objective of the present invention is to provide a process for the synthesis of high molecular weight polyurethane copolymers having chemical linkages such as ester, ether, amide, urea and carbonates.

Yet another objective of the present invention is to promote the transurethane process by using catalysts from metal, metal oxides, transition metal oxides, transition metal coordination compounds, compounds containing lanthanides and actinides.

### SUMMARY OF THE INVENTION

Accordingly, the present invention provides a solvent free, non isocyanate, process for the preparation of polyurethane or its co-polymer having formula 1, 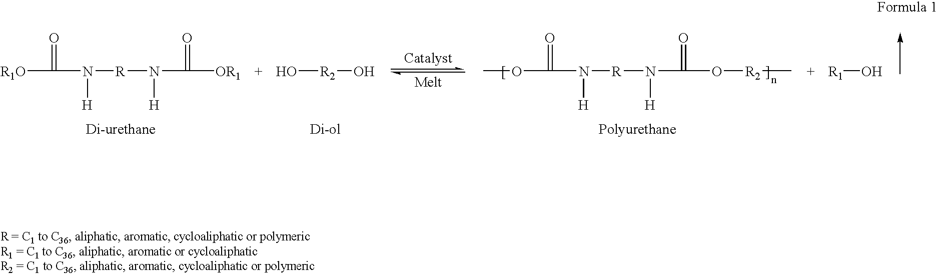
which comprise condensing di-urethane monomer with diol, in the presence of a catalyst, at a temperature in the range of 50-300° C. to obtain the resultant melt, removing oxygen completely from the above said melt by purging it with nitrogen, under vacuum pressure of 1-0.00 1 mm Hg for its subsequent evacuation, under stirring, cooling and continuing the above said polymerization reaction for a period of 4-24 hrs, followed by the removal low boiling alcohols from the above said melt condensation to obtain the desired polymer, blending the resultant trans poly urethane with thermoplastics or thermosets either in solution or melt, in a molar or weight ratio of 1 to 99% to obtained the desired polymer blend.

In an embodiment of the present invention the polyurethanes and its copolymers obtained are represented by a group of following types of polymer: A-A+B—B, A-B, Aₓ-B, A-Bₓ, A-A+B—B+Aₓ-B; A-A+B—B+A-Bₓ and A-B+Aₓ-B or A-B+A-Bₓ where x=1-20 and A and B are urethane and hydroxyl functionality, respectively.

In yet another embodiment the di-urethane monomer used is selected from the group consisting of aromatic, aliphatic and cycloaliphatic di-urethane.

In yet another embodiment the aromatic di-urethane used is based on the ring structure of toluene, terephthalic, isophthalic, naphthalene or anthracene.

In yet another embodiment a process as claimed in claim 1, wherein the aliphatic di-urethane monomer used is based on aliphatic units of —(CH₂)ₓ—, where x=1, 2, 3, . . . 100.

In yet another embodiment A process as claimed in claim 1, wherein the cycloaliphatic di-urethane monomer used is based on mono, di, tri or multiple cycloaliphatic rings.

In yet another embodiment the cycloaliphatic compound used is selected from the group consisting of cyclohexyl, methylene biscyclohexyl, biscyclohexyl and tricyclodecane.

In yet another embodiment A process as claimed in claim 1, wherein the diol used is selected from H(OCH₂CH₂)ₓOH and HO(CH₂)ₓOH, where x=1, 2, 3, . . . 100

In yet another embodiment the diol used is selected from aliphatic, cycloaliphatic and aromatic diols.

In yet another embodiment the cycloaliphatic diol used is selected from mono, di, tri and multiple cycloaliphatic diols.

In yet another embodiment the cycloaliphatic diol used is selected from the group consisting of cyclohexanedimethanol, methylene biscyclohexyl diol, biscyclohexyl diol, cyclohexane diol and tricyclodecanedimethanol.

In yet another embodiment the diol used is polyol containing polymer selected from the group consisting of polyesters, polyethers, polyamides, polycarbonates, polysulfones, poly acrylics, polystyrene and other thermoplastics

In yet another embodiment the catalyst used is selected from the group consisting of alkali, alkaline earth metal, carboxylic acid salts and a mixture thereof.

In yet another embodiment the catalyst used selected from the group consisting of oxides, acetates, alkoxides, phosphates, halides and coordination complexes of alkali, alkaline earth metals, transition metals, non-metals, lanthanides and actinides.

In yet another embodiment the amount of catalyst used is in the range 1 to 99 mole or weight percent

In yet another embodiment the transurethane polymer obtained has high intrinsic viscosity in the range of 0.2 to 1.0 and melt viscosity in the range of 1000 to 10,000 poise.

In yet another embodiment the transurethane polymer obtained has thermal stability up to 300° C.

In yet another embodiment the transurethane polymer obtained has glass transition temperature in the range of −60 to 250° C.

In yet another embodiment the transurethane polymer obtained has percent crystallinity in the range of 5 to 95%

In yet another embodiment the transurethane polymer obtained is blended with thermoplastics or thermosets in both solution and melt in the composition range of molar or weight ratio of 1 to 99%.

In yet another embodiment the polyurethanes and polyurethane/thermoplastic blends obtained is either thermally processed or solution caste.

In yet another embodiment the thermoplastic used is selected from the group consisting of polyethylene, polyesters, polyamides, polyethers, polycarbonates, poly(vinylchloride), polystyrene, polypropylene, poly(methylmethacrylate), poly(vinylacetate), polyureas, polyurethanes, polysulfones and polyimides.

### DETAILED DESCRIPTION OF THE INVENTION

According to a feature of the present invention the polyurethanes containing random branched, hyperbrached, dendritic, graft, kinked copolymers and liquid crystalline polymers can be prepared by the above said process. In the present process the glass transition temperature (from −60 to 250° C.) and the percent crystallinity (5 to 95%) can be fine-tuned by using different types of diol and di-urethane monomers. The thermal stability of the polyurethanes prepared in this process is highly stable up to 300° C. The polyurethanes prepared by the melt transurethane process are useful to prepare polyurethane blends with other thermoplastics. The above said transurethane process is also very efficient for reactive blending of polyurethanes with thermoplastics and thermosets to obtain thermally stable, crystalline, good morphology, thermo-reversible elastomeric polyurethanes with thermal stability up to 300° C.

### BRIEF DESCRIPTION OF THE DRAWINGS

The other objectives, features and advantages of the invention will became apparent from the description and the accompanying drawing in which,

FIG. 1. Schematic representation of melt transurethane process

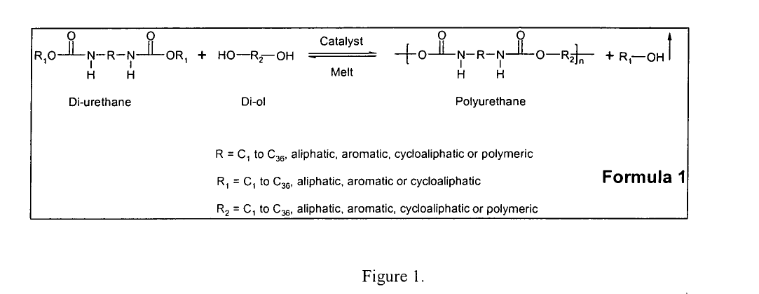

FIG. 2. Represents the ¹³C-NMR spectra (in CDCl₃) of the polyurethane is prepared in example 2 using the process in formula 1. The vanishing of OCH₃ carbon atom peat at 52 ppm (corresponding to the di-urethane monomer) in the polymer confirms the melt transurethane process and formation of high molecular weight polyurethanes.

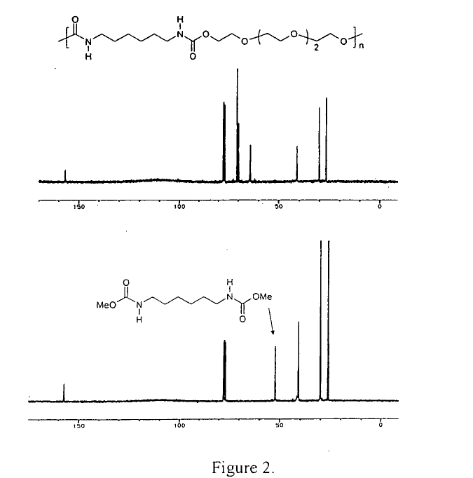

FIG. 3. Represents the TGA plot of polyurethane described in example 2 using the process in formula 1.

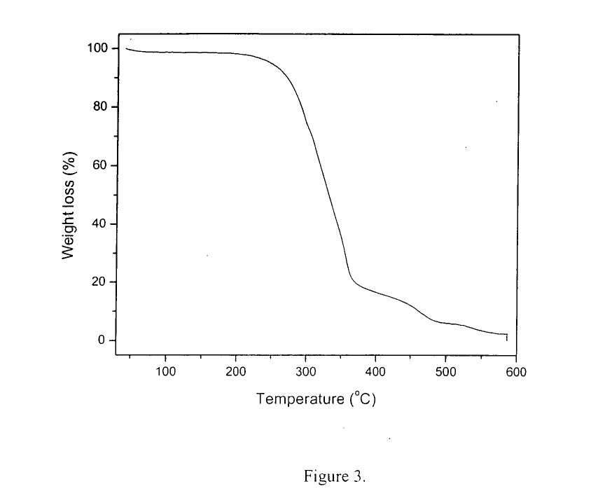

A preferred embodiment of the present invention will now be explained with reference to the accompanying drawings. It should be understood however that the disclosed embodiment is merely exemplary of the invention, which may be embodied in various forms. The following description and drawings are not to be construed as limiting the invention and the numerous specific details are described to provide a thorough understanding of the present invention, as the basis for the claims and as a basis for teaching one skilled in the art how to make and/or use the invention. However in certain instances, well-known or conventional details are not described in order not to unnecessarily obscure the present invention in detail.

The present invention essentially comprises of preparation of polyurethanes in a melt transurethane process under solvent free conditions using non-toxic di-urethane monomers and diols. The process showed in Formula 1 is very efficient in producing high molecular weight polyurethanes for various types of simple diols such as H(OCH₂CH₂)ₓOH and HO(CH₂)ₓOH, where x=1, 2, 3, . . . n and also polyols containing polyether, polyester, polycarbonate, polyamide or polymethylene chains. The di-urethane monomers employed in the formula 1 can be aromatic, aliphatic, cycloaliphatic or any long polymer chains. The transurethane process can also be performed for synthesis of thermoplastic or thermoset polyurethanes in solution and melt. By varying the polymerization conditions such as temperature, catalysts, catalyst amount, stirring rate, stirrer type, applied vacuum and polymerization reaction time, the molecular weight of the resultant polyurethanes can be controlled.

In a preferred embodiment of the present invention that the di-urethane monomers can be prepared using commercially available diisocyanates by reacting with simple alcohols such as methanol and ethanol in a less expensive processing at ambient temperature with the product formation of high purity and high yield

In another embodiment of the present invention that the transurethane process can be

promoted by using catalysts from metal, metal oxides, transition metal oxides, transition metal coordination compounds, compounds containing lanthanides and actinides. The catalysts can be used for the transurethane process both in the first stage of making the polyurethanes oligomers and also for the subsequent polycondensation reactions.

In yet another embodiment of the present invention that melt transurethane polymerization process can be used to make thermosets by reacting di-urethane with multi functional alcohols or diols with multifunctional urethane monomers in solvent free conditions at high temperatures. The process can also be utilized to prepare thermosets during the molding of desired objects by pouring the mixture of the monomers and catalyst to a scaffold and subsequently apply the desire temperature and vacuum.

In yet another embodiment of the present invention that melt transurethane polymerization process can be utilized to prepare a homo and copolymers of random branched, hyperbranched, dendritic structures, graft copolymers, kinked copolymers and liquid crystalline polymers.

According to other features of the present invention, the polymers produced through the transurethane reaction can be processed into thin films and any objects through solution casting and melt processing techniques. The melt processing includes hot pressing, extrusion, compressive molding and abrasive molding techniques. In the present invention, the high thermal stability of the polyurethanes and its copolymers can be obtained up to 300° C. for various high temperature applications. The glass transition temperature of the polymers prepared by this process can be varied from −60 to 220° C. using a suitable diol or di-urethane monomers. The percent crystallinity of the polymers prepared by this process can also be controlled from 5 to 95% by using suitable aromatic, aliphatic or cycloaliphatic derivatives.

The important finding of the present invention is that adopting a new melt transurethane reaction, polyurethanes can be prepared through a low cost melt process using cheap reagents in an eco-friendly approach. The present synthetic approach is also easily adaptable to large-scale manufacturing.

The invention is described in detail in the following examples, which are given by way of illustration only and therefore should not be construed to limit the scope of the present invention.

### EXAMPLE 1

Synthesis of di-urethane monomers: A typical procedure for reaction between hexamethylenediisocyanate (HMDI) and methanol is described as an example for di-urethane synthesis. Methanol (6.4 ml, 5.0 g, 156 mmol) was taken in a 25 ml two necked flask equipped with a nitrogen inlet. To this dibutyltindiluarate (6 drops) was added as a catalyst for the reaction and the flask was cooled to −20° C. using an ice-salt bath. HMDI (5.0 g, 29 mmol) was added drop wise and the reaction mixture was slowly warmed to 30° C. and stirred for 0.5 h and subsequently heated to 65° C. and the reaction was continued for 18 h. The contents of the flask was cooled and precipitated into large amount methanol and filtered to obtain a white powder. The crude product was purified by crystallizing from hot methanol and dried in a vacuum oven at 55° C. (0.5 mm Hg) for 12 h. m.p.=80° C.

### EXAMPLE 2

Melt Transurethane Reaction for the Preparation of polyurethane: A typical procedure for melt transurethane process was described for the above synthesized di-urethane monomer and tetra ethylene glycol. Tetraethylene glycol (0.92 g, 4.75 mmol), di-urethane monomer (1.10 g, 4.75 mmol) and titaniumtetrabutoxide (6 drops) as a catalyst were taken in a glass cylindrical melt condensation apparatus. The polymerization apparatus has been provided with inlet and outlet for purging nitrogen and applying vacuum. The polymerization content was melted by placing the apparatus in oil bath at 100° C. The melt was purged with nitrogen while stirring and then subsequently evacuated. The process was repeated for at least three times to remove the oxygen completely from the reaction medium. The polymerization was continued by stirring the melt under a steady flow of nitrogen at 130° C. for 4 h. The viscous oligomeric melt was then heated to 150° C. and vacuum was applied gradually to 0.01 mm of Hg in 30 minutes. The polymerization was continued at this condition for additional 2 h. High viscous polyurethane was obtained at the end of the melt transurethane process.

### EXAMPLE 3

Melt Transurethane Reaction for Preparation of polyurethane from oligo or poly ethylene glycols: The melt transurethane process is adopted to synthesis various polyurethanes from commercially available oligoethylene glycols such as mono, di, tri and tetra ethylene glycols and polyethylene glycols of various molecular weights such as PEG 300, PEG 600, PEG 1000, PEG 1500 and PEG 3000. Equimolar amount of the diols are polymerized with di-urethane monomer as described in example 2 and high viscous polyurethane was obtained at the end of the melt transurethane process.

### EXAMPLE 4

Melt Transurethane Reaction for Preparation of polyurethane from simple aliphatic diols and poly methylene diols: The melt transurethane process is adopted to synthesis various polyurethanes from commercially available simple aliphatic diols such as ethylene glycol, propane diol, butanediol, and diols having general formula HO(CH₂)ₓOH, where x=1, 2, 3 . . . 100. Equimolar amount of the diols are polymerized with di-urethane monomer as described in example 2 and high viscous polyurethane was obtained.

### EXAMPLE 5

Melt Transurethane Reaction for Preparation of polyurethane from cycloaliphatic diols: The melt transurethane process is adapted to synthesis various polyurethanes from commercially available mono, di, tri and multiple cycloaliphatic diols such as tricyclodecane dimethanol (TCD-DM) and cyclohexanedimthanol (CHDM). Equimolar amount of the diols are polymerized with di-urethane monomer as described in example 2 and high viscous polyurethane was obtained at the end of the melt transurethane process.

### EXAMPLE 6

Melt Transurethane Reaction for Preparation of polyurethane from polyols: The melt transurethane process is adopted to synthesis various polyurethanes from commercially available polyols containing polyether, polyester, polycarbonate, polyamide, polysulfone, etc. Equimolar amount of the diols are polymerized with di-urethane monomer as described in example 2 and high viscous polyurethane was obtained

### EXAMPLE 7

Melt Transurethane Reaction for Preparation of polyurethane from various di-urethanes: The melt transurethane process is adopted to synthesis various polyurethanes from di-urethane monomers prepared from aromatic diisocyanates having the ring structures of 2,6-toluene, terephthalic, isophthalic, naphthalene, anthracene, etc; aliphatic diisocyanates general formula OCN(CH₂)ₓNCO, where x=1, 2, 3 . . . 100; and cycloaliphatic diisocyanates such as 1,4-cyclohexyldisiocyanate, isophoronediisocyanate and methylenebiscyclohexanediisocyanate. Equimolar amount of the diols described in examples 2 to 6 are polymerized with di-urethane monomers as described in example 2 and high viscous polyurethane was obtained at the end of the melt transurethane process.

### EXAMPLE 8

Melt Transurethane Reaction for Preparation of polyurethane at various polymerization conditions : The melt transurethane process is adopted to synthesis various polyurethanes by varying the polymerization temperatures from 100 to 300° C., stirring rate of the melt from 10 to 3000 rpm and apply the vacuum in the range of 1 to 0.001 mm of Hg. Equimolar amount of the diols and di-urethanes described in examples 2 to 7 are polymerized to produce high viscous polyurethane at the end of the melt transurethane process.

### EXAMPLE 9

Melt Transurethane Reaction for Preparation of polyurethane using various catalysts: The melt transurethane process is adopted to synthesis various polyurethanes using various catalysts using the catalyst selected from the group consisting of alkali and alkaline earth metal carboxylic acids, oxides, acetates, alkoxides, coorodination complexes of alkali, alkaline earth metal, transition metals, non-metals, lanthanides and actinides. The concentration of the catalysts varied form 1 to 1000 mole equivalents in the polymerization reaction. The different types of diols, di-urethanes and polymerization conditions described in examples 2 to 8 are followed for each catalyst to produce high viscous polyurethane at the end of the melt transurethane process.

Advantages

The new melt transurethane process has many advantages over the conventional isocyanate route employed for the polyurethanes. In the new process the polyurethane can be processed in a solvent free and non-isocyanate melt conditions, therefore, the obtained polymeric products are free from solvent and un-reacted isocyanate impurities. The new process is efficient in producing new polymeric materials showing vast promise for industrial applications ranging from thermoset devices, paints, elastomers, biomaterials, microelectronics, polymer electrolytes, rechargeable batteries, solar cells, bio-sensors and light emitting diodes etc. The polymers prepared through transurethane polymerization process can be utilized for various application in nano-technology and biomedical, biodegradable plastic applications.

The polyurethanes produced by the new process can be used to prepare thermoplastic/thermoset blends in solution casting and melt processing via hot pressing, extrusion, compressive molding and abrasive molding techniques. The composites containing plastics such polyethylene, polyesters, polyamides, polyethers, polycarbonates, poly(vinylchloride), polystyrene, polypropylene, poly(methylmethacrylate), poly(vinylacetate), polyureas, polyurethanes, polysulfones, polyimides, and ethylene vinyl acetate, etc can be prepared. The polyurethanes and polyurethane/thermoplastic blends is thermally processed or solution casted into highly free standing flexible films and bars of thickness varying from 1 micron to 10 cm size. The thermoplastics/thermosets and polyurethanes can be thermally stable, crystalline, having a good morphology and elastomeric. The present invention is also very useful for the preparation of polyurethane foams, adhesives, paints, coatings, fibers, etc, using melt transurethane process.

We claim:

1. A solvent free, non isocyanate, melt transurethane process for the preparation of polyurethane or its co-polymer having formula 1, 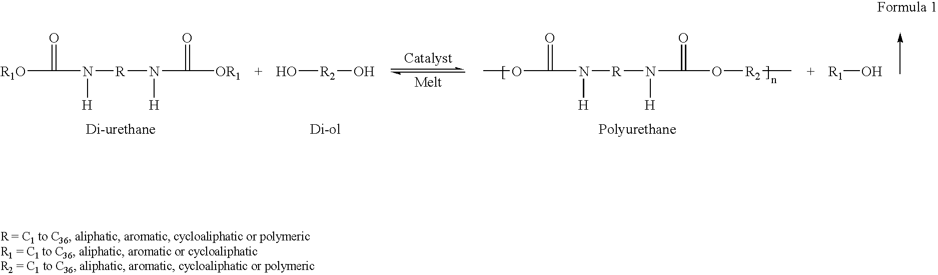
which comprise condensing di-urethane monomer with diol, in the presence of a catalyst, at a temperature in the range of 50-300° C. to obtain the resultant melt, removing oxygen completely from the above said melt by purging it with nitrogen, under vacuum pressure of 1-0.001 mm Hg for its subsequent evacuation, under stirring, cooling and continuing the above said polymerization reaction for a period of 4-24 hrs, followed by the removal low boiling alcohols from the above said melt condensation to obtain the desired polymer, blending the resultant trans poly urethane with thermoplastics or thermosets either in solution or melt, in a molar or weight ratio of 1 to 99% to obtained the desired polymer blend.

2. A process according to claim 1, wherein the polyurethanes and its copolymers obtained are represented by a group of following types of polymer: A-A+B—B, A-B, Aₓ-B, A-Bₓ, A-A+B—B+Aₓ-B; A-A+B—B+A-Bₓ and A-B+Aₓ-B or A-B+A-Bₓ where x=1-20 and A and B are urethane and hydroxyl functionality, respectively.

3. A process according to claim 1, wherein the di-urethane monomer used is selected from the group consisting of aromatic, aliphatic and cycloaliphatic di-urethane.

4. A process according to claim 1, wherein the aromatic di-urethane used is based on the ring structure of toluene, terephthalic, isophthalic, naphthalene or anthracene.

5. A process according to claim 1, wherein the aliphatic di-urethane monomer used is based on aliphatic units of —(CH₂)ₓ—, where x=1, 2, 3, . . . 100.

6. A process according to claim 1, wherein the cycloaliphatic di-urethane monomer used is based on mono, di, tri or multiple cycloaliphatic rings.

7. A process according to claim 6, wherein the cycloaliphatic compound used is selected from the group consisting of cyclohexyl, methylene biscyclohexyl, biscyclohexyl and tricyclodecane.

8. A process according to claim 1, wherein the diol used is selected from H(OCH₂CH₂)ₓOH and HO(CH₂)ₓOH, where x=1, 2, 3 ,. . . 100

9. A process according to claim 1, wherein the diol used is selected from aliphatic, cycloaliphatic and aromatic diols.

10. A process according to claim 1, wherein the cycloaliphatic diol used is selected from mono, di, tri and multiple cycloaliphatic diols.

11. A process according to claim 1, wherein the cycloaliphatic diol used is selected from the group consisting of cyclohexanedimethanol, methylene biscyclohexyl diol, biscyclohexyl diol, cyclohexane diol and tricyclodecanedimethanol.

12. A process according to claim 1, wherein the diol used is polyol containing polymer selected from the group consisting of polyesters, polyethers, polyamides, polycarbonates, polysulfones, poly acrylics, polystyrene and other thermoplastics

13. A process according to claim 1, wherein the catalyst used is selected from the group consisting of alkali, alkaline earth metal, carboxylic acid salts and a mixture thereof.

14. A process according to claim 1, wherein the catalyst used selected from the group consisting of oxides, acetates, alkoxides, phosphates, halides and coordination complexes of alkali, alkaline earth metals, transition metals, non-metals, lanthanides and actinides.

15. A process according to claim 1, wherein the amount of catalyst used is in the range 1 to 99 mole or weight percent

16. A process according to claim 1, wherein the transurethane polymer obtained has high intrinsic viscosity in the range of 0.2 to 1.0 and melt viscosity in the range of 1000 to 10,000 poise.

17. A process according to claim 1, wherein the transurethane polymer obtained has thermal stability up to 300° C.

18. A process according to claim 1, wherein the transurethane polymer obtained has glass transition temperature in the range of −60 to 250° C.

19. A process according to claim 1, wherein the transurethane polymer obtained has percent crystallinity in the range of 5 to 95%

20. A process according to claim 1, wherein the transurethane polymer obtained is blended with thermoplastics or thermosets in both solution and melt in the composition range of molar or weight ratio of 1 to 99%.

21. A process according to claim 20, wherein the polyurethanes and polyurethane/thermoplastic blends obtained is either thermally processed or solution caste.

22. A process according to claim 20, wherein the thermoplastic used is selected from the group consisting of polyethylene, polyesters, polyamides, polyethers, polycarbonates, poly(vinylchloride), polystyrene, polypropylene, poly(methylmethacrylate), poly(vinylacetate), polyureas, polyurethanes, polysulfones and polyimides.
